(19) United States
(12) Patent Application Publication
(10) Pub. No.: US 2020/0322428 A1
(43) Pub. Date: Oct. 8, 2020

(54) SYSTEMS AND METHODS FOR USING A LOCAL COMPUTING DEVICE TO SUPPORT COMMUNICATION WITH A REMOTE COMPUTING DEVICE

(71) Applicant: Toshiba Global Commerce Solutions Holdings Corporation, Tokyo (JP)

(72) Inventors: Neil A. Girard, Research Triangle Park, NC (US); Brad M. Johnson, Research Triangle Park, NC (US); Adrian Rodriguez, Research Triangle Park, NC (US); David Steiner, Research Triangle Park, NC (US)

(21) Appl. No.: 16/374,782

(22) Filed: Apr. 4, 2019

(51) Int. Cl. H04L 29/08; H04L 12/24; G06Q 30/02

(52) U.S. Cl. CPC H04L 67/1082; H04L 41/0816; G06Q 30/0208; H04L 41/5096; H04L 41/5025

(57) ABSTRACT

Systems and methods for using a local computing device to support communication with a remote computing device are disclosed. According to an aspect, a method includes determining a communication condition over a first network. The method also includes sending a request over a second network for one or more other computing devices to support communication for the first computing device over a second network in response to determining the communication condition. Further, the method includes receiving, from the one or more other computing devices, indication whether the request is accepted. The method also includes using the one or more other computing devices for communication over the second network based on the received indication.

### TECHNICAL FIELD

The presently disclosed subject matter relates generally to computing devices and communications networks. Particularly, the presently disclosed subject matter relates to systems and methods for using a local computing device to support communication with a remote computing device.

### BACKGROUND

Computing devices, such as servers, typically rely on remote computing devices for additional processing capabilities and other services. As an example, desktop computers, laptop computers, and smartphones often connect to the Internet to offload tasks, to store data, and to access data stored at other computing devices. Maintaining connectivity is important so that such processing capabilities and other services are continued uninterrupted.

In a retail environment, such as a grocery store or other “brick and mortar” store, customers typically shop within a store and subsequently proceed to checkout for purchase of items at a point of sale (POS) terminal. A customer may provide a payment card, such as a credit card or a debit card, for processing in order to pay for items. The POS terminal may connect to a communications network, such as the Internet, in order to present transaction information to a server of an acquiring financial institution (e.g., bank) for verification of the payment card number, the transaction type, and the amount with the issuer (e.g., the payment card-issuing bank). The server of the acquiring bank may generate and send to the POS terminal an approval code for the transaction. For these reasons, connectivity of a POS terminal is very important in order to process purchase transaction and to keep customers satisfied. In addition, retail stores can have computing devices that connect to remote computing devices for other tasks such as augmented reality processing, natural language processing, and retailer server functions.

For at least the aforementioned reasons, there is a continuing need for improved systems and techniques for maintaining connectivity among computing devices.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a retail environment system according to embodiments of the present disclosure;

FIG. 2 is a flow chart of an example method for managing communications over different networks by use of multiple computing devices in accordance with embodiments of the present disclosure;

FIG. 3 is a block diagram of an example computing device that is local and may be used as an alternative for connecting POS terminal to a remote server in accordance with embodiments of the present disclosure; and

FIG. 4 is a flow chart of an example method implemented at a computing device that is local to a retail environment and that may be used as an alternative for connecting a computing device of the retail environment to a remote server in accordance with embodiments of the present disclosure.

### SUMMARY

The presently disclosed subject matter includes systems and methods for using a local computing device to support communication with a remote computing device. According to an aspect, a method includes determining a communication condition over a first network. The method also includes sending a request over a second network for one or more other computing devices to support communication for the first computing device over a second network in response to determining the communication condition. Further, the method includes receiving, from the one or more other computing devices, indication whether the request is accepted. The method also includes using the one or more other computing devices for communication over the second network based on the received indication.

According to another aspect, a method includes receiving a request over a first network to support communication for a second computing device over a second network. The method also includes receiving user input indicating whether the request is accepted. Further, the method includes communicating the indication to the second computing device via the first network. The method also includes receiving data from the second computing device via the first network. Further, the method includes routing the received data to a third computing device via the second network.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

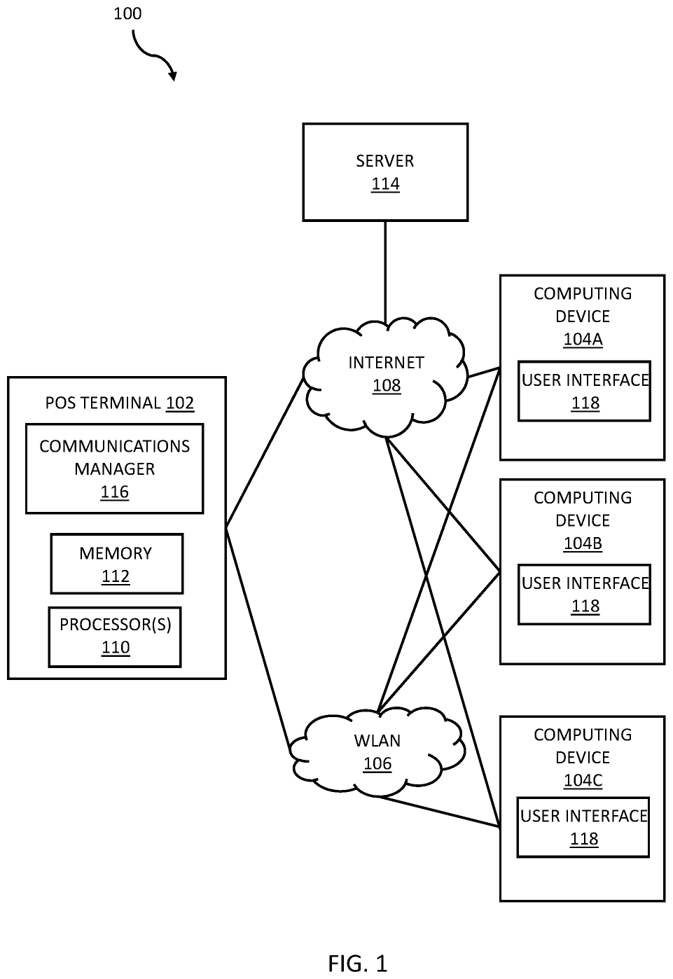

FIG. 1 illustrates a block diagram of a retail environment system 100 according to embodiments of the present disclosure. It is noted that the system 100 shown in FIG. 1 may be implemented by any other suitable system having multiple computing devices operable to connect to other remote computing devices via two or more networks. As described in further detail herein, one of the computing devices may, in response to determining a communication condition over one of the network, send a request over a second network for another computing device to support communication for the first computing device over the other network. The first computing device may use the other computing device for communication over the other network if the request is accepted. Additional details about this functionality, including its implementation by the system 100, are described herein.

Referring to FIG. 1, the system 100 includes a POS terminal 102 and multiple, mobile computing devices 104A, 104B, and 104C. The POS terminal 102 is configured to communicate with computing devices 104A, 104B, and 104C via a wireless local area network (WLAN) 106. Alternative to the WLAN 106, the computing devices 104A, 104B, and 104C may be communicatively connected to the POS terminal 102 by any other suitable connection. Further, alternative to the POS terminal 102, any suitable computing device of the retailer, such as a server, at the retail store may implement the functionality of the POS terminal 102. For ease of illustration, only the POS terminal 102 of the retailer's computing devices is shown and described as communicating with the computing devices 104A, 104B, and 104C, but it should be understood that one or more other computing devices of the retailer may implement the functionality in accordance with embodiments of the present disclosure. Computing devices 104A, 104B, and 104C may be smartphones or tablet computers operated by different customers of a retail store within which system 100 operates. Computing devices 104A, 104B, and 104 may be communicatively connected to the Internet 108 by any suitable system such as a cellular network and/or any other suitable network.

The POS terminal 102 may be communicatively coupled to a scanner and a user interface. The POS application may execute on one or more processors 110 of the POS terminal 102. The POS application may be stored on memory 112 accessible by the processor(s) 110. The POS terminal 102 may include any suitable hardware, software, and/or firmware for implementing functions and processes in accordance with embodiments of the present disclosure. The system 100 may include any number of POS terminals, and only one POS terminal is shown in FIG. 1 for convenience of illustration.

The scanner of the POS terminal 102 may be capable of reading a machine-readable image representing data from one or more items for purchase. In an example, the machine-readable image on the item(s) may represent identification of the purchase item. Identification of the item may alternatively be provided to the POS application by, for example, a user entering an identifier, such as a number, representing the item. The identification may be used for accessing data associated with the purchase item, such as, but not limited to, information for determining a category or pricing of the item.

The user interface of the POS terminal 102 may include a keyboard device or touch display that enables a shopper or retail personnel, such as a cashier, to input information and to be presented with information or graphics related to a purchase transaction. For example, a customer may input account and payment information for processing by the POS terminal 102. The user interface may include a scanning device with a keypad for reading a shopper's payment card (e.g., credit card or debit card) including account number. The user interface may be rendered on a display attached to the POS terminal. The keypad device on the financial card scanning device may enable a shopper to enter a personal identification number (PIN) if using a debit card or other payment card that requires the PIN be entered. The user interface may include the display for displaying purchase and transaction information to the shopper.

Once payment card information is obtained, the POS terminal 102 may connect to a remotely-located server 114 via the Internet 108. The server 114 may be operated by a financial institution for verification of the payment card number, the transaction type, and the amount with the issuer. Once verified, the POS terminal 102 may proceed with completing the transaction.

In some instances, computing devices within a retail store may implement functions such as augmented reality processing, natural language processing, and retailer server functions. Processing for such functions may be offloaded to a remote server, such as server 114. For example, the POS terminal 102 may communicate, via the Internet 108, data associated with these functions to the server 114 or another server. The remote server may subsequently process the data and return output to the POS terminal 102 and/or another computing device within the retail store.

In accordance with embodiments, the POS terminal 102 may include a communications manager 116 configured to determine a communication condition over a network. For example, the communications manager 116 may determine a communication condition between the POS terminal 102 and the server 114 over one or more networks, including the Internet 108. The communications manager 116 may determine, for example but not limited to, that communication over the Internet 108 and/or another network has failed or that communication over the Internet 108 and/or another network is below a predetermined threshold of criterion or criteria. Example techniques for recognizing that communication over a network has failed includes, but are not limited to, latency in the responses form the sever, timeouts from outgoing requests, connection error or disconnections from existing sockets or ports, or the like. The POS terminal 102 may receive information or some indication from a computing device within the retail environment that indicates communication has failed or does not meet the threshold.

Subsequent to determining the communication condition, the communications manager 116 can send a request over another network for one or more other computing devices to support communication for the POS terminal 102 over a network. The communications manager 116 can send the request in response to determining that the communication condition (e.g., that the communication over a network has failed or below a predetermined threshold of criterion). As an example, the POS terminal may send requests to one or more of computing devices 104A, 104B, and 104C over the WLAN 106. Each request may ask that the respective computing devices 104A, 104B, and 104C provide support to communication of the POS terminal 102 to and from other computing devices, such as the server 114. The request may be presented to a user of the computing device, and the user may be prompted to respond to the request. The user may enter a response into a user interface 120 of the computing device to either accept or decline the request. One or more of the computing devices 104A, 104B, and 104C may communicate to the POS terminal 102 an indication of whether the request is accepted or declined.

At the POS terminal 102, the indication(s) of whether the request is accept or declined. The communications manager 116 may receive the indication(s). In an example, the POS terminal 102 may receive an indication from the computing device 104A that the request is accepted. In response to the acceptance, the POS terminal 102 may use the accepting computing device 104A for communication with the server 114. In this example, the communication between the POS terminal 102 and the server 114 may be through the computing device 104A via WLAN 106 and the Internet 108. The computing device 104A may communicate with the server 114 via, for example, a cellular connection and an Internet connection. Example communications may be to engage the remote computing device (e.g., server 114) for conducting retail server functions, data processing offload from the POS terminal 102, augmented reality processing, natural language processing, and the like.

In another example, the POS terminal 102 may receive an indication from the computing device 104B that the request is declined. In this example, the POS terminal 102 may prevent use of the computing device 104B for communication over another network.

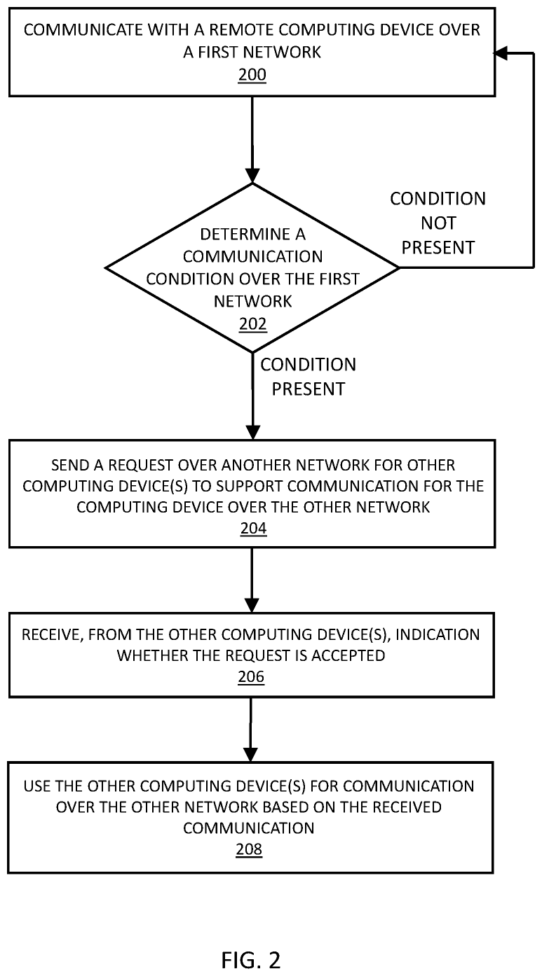

FIG. 2 illustrates a flow chart of an example method for managing communications over different networks by use of multiple computing devices in accordance with embodiments of the present disclosure. The method of FIG. 2 is described in this example as being implemented by the system 100 shown in FIG. 1, although it should be understood that the method may be implemented by any suitable system. Further, the method of FIG. 2 is described as being implemented within a retail environment, but it may be implemented within any suitable environment having a computing device that may need communications with a remote computing device.

Referring to FIG. 2, the method includes communicating 200 with a remote computing device over a network. For example, the POS terminal 102 may communicate with the server 114 for supporting functions, such as conducting a purchase transaction and data processing offload, implemented at the POS terminal 102. In an example, the POS terminal 102 may receive transaction information by scanning a customer's payment card when the customer is at the POS terminal 102 for purchasing items. The POS terminal 102 may connect to the Internet 108 and/or other networks in order to present the transaction information to the server 114, which is a server of an acquiring financial institution for verification of the payment card number, the transaction type, and the amount with the issuer (e.g., the payment card-issuing bank). The server of the acquiring bank may generate and send to the POS terminal 102, via the Internet 108, an approval code for the transaction. The POS terminal 102 may communicate with the server 114 and/or another computing device for these functions or other functions.

The method of FIG. 2 includes determining 202 a communication condition over the network. Continuing the aforementioned example, the communications manager 116 of the POS terminal 102 may determine a communication condition over the Internet 108. The communication condition may be, for example, but not limited to, that the Internet connection has failed or that communication over the Internet 108 is below a predetermined threshold of criterion. Example indicators that communication over a network is below a predetermined threshold of criterion include, but are not limited to, response time being too long or too many network hops between the host and the end point. Although communication between the POS terminal 102 and the server 114 is described in this example as being through the Internet 108, the POS terminal 102 and the server 114 may be through one or more other suitable networks. The POS terminal 102 may similarly determine a communication condition of these other network(s).

In response to determining that the communication condition is not present at block 202, the method may return to block 200. Continuing the aforementioned example, the POS terminal 102 may continue communicating with the remote computing device over the network at step 200. In this instance, it is assumed that the communication condition is adequate for continuing to support communication to the server 114 in the same manner. The communications manager 116 may continue to monitor the communication condition.

In response to determining that the communication condition is present, the method of FIG. 1 includes sending 204 a request over another network for one or more other computing devices to support communication for the computing device over the other network. Continuing the aforementioned example, the POS terminal 102 may send a request to the computing devices 104A, 104B, and/or 104C to support communication for the POS terminal 102. Particularly, the POS terminal 102 may request that the computing devices 104A, 104B, and/or 104C assist the POS terminal 102 with communicating with the server 114 via the WLAN 106. The communication may be used to support functions, such as conducting a purchase transaction, data processing offload, or the like. The request may be received by one or more of the computing devices 104A, 104B, and 104C. A user operating a respective one of the computing devices 104A, 104B, and/or 104C may select whether or not to accept the request. In response to acceptance or decline, the computing device (either 104A, 104B, or 104C) may send to the POS terminal 102 whether the request was accepted or declined.

The POS terminal 102 and a computing device (e.g., computing device 104A, 104B, or 104C) may be communicatively connected by any suitable technique. In an example, the POS terminal 102 can make a direct connection (point to point) to the computer device or different communication technique (e.g., BLUETOOTH® wireless communication) to connect to the mobile device. The computing device may become an access point for the POS terminal 102 to access the Internet. All or at least some of the traffic can be routed to a single computing device or it can be split between multiple devices as described in the system 100 shown in FIG. 1.

The method of FIG. 2 includes receiving 206, from the other computing device(s), indication whether the request is accepted. Continuing the aforementioned example, the communications manager 116 of the POS terminal 102 may receive a message from one or more of the computing devices 104A, 104B, and 104C that indicates whether the request is accepted or declined. In response to receiving a message that the request is declined, then the POS terminal 102 will not use that respective computing device for communications with the server 114. In response to receiving a message that the request is accepted, the communications manager 116 may use the accepting computing device (one of computing devices 104A, 104B, and 104C) for communication over the WLAN 106. This communication link may be used to thereby communicate with the server 114. More particularly, communication between the POS terminal 102 and the server 114 may be via the WLAN 106, the accepting computing device (one of computing devices 104A, 104B, and 104C), and the Internet 108 and/or another suitable network. This communication arrangement is established, because of the communication condition (e.g., the Internet connection has failed or that communication over the Internet 108 is below a predetermined threshold of criterion) between POS terminal 102 and server 114 via the Internet 108 directly.

With continuing reference to FIG. 2, the communication for the POS terminal 102 over the Internet 108 may be continuously or periodically monitored. If there is a change such that the communication condition is no longer met or communication is sufficiently adequate by some criterion, the POS terminal 102 may determine the change and subsequently switch from using one of the computing devices 104A, 104B, or 104C to directly communicating with the server 114, such as via the Internet 108, without use of one of the computing devices 104A, 104B, or 104C.

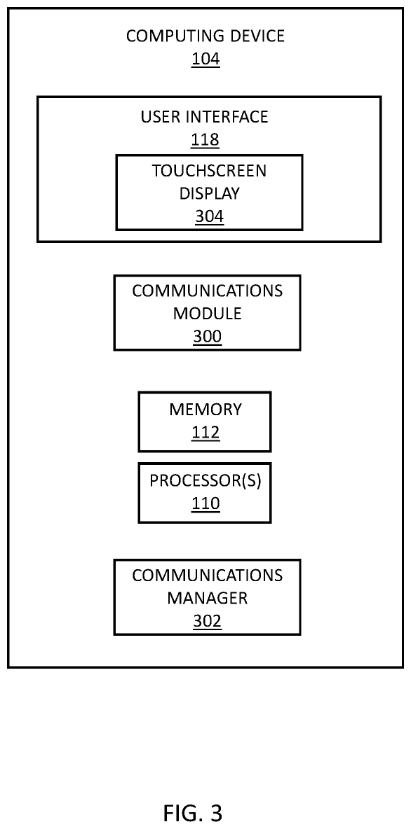

FIG. 3 illustrates a block diagram of an example computing device 104 that is local and may be used as an alternative for connecting POS terminal to a remote server in accordance with embodiments of the present disclosure. In this example, the computing device 104 is described as being a smartphone, but it is noted that the computing device 104 may be any suitable computing device capable of communicating with a POS terminal, such as POS terminal 102 shown in FIG. 1, or any other computing device. Further, in this example, the computing device is described as being located within a retail environment and operable for wirelessly communicating with a WLAN (e.g., WLAN 106) within the retail environment. The POS terminal may be communicatively connected to the WLAN and the Internet.

Referring to FIG. 3, the computing device 104 includes a communications module 300 operable to communicatively and wirelessly connect the computing device 104 with the POS terminal via a WLAN. Further, the communications module 300 and/or another communications module of the computing device 103 may be configured to communicate with a cellular network to thereby communicate with the Internet.

In accordance with embodiments of the present disclosure, the communications module 300 of the computing device 104 may receive a communication from the POS terminal via the WLAN. The communication may include a request that the POS terminal use the computing device 104 as a passthrough for supporting communications between the POS terminal and a remote server, such as the server 114. The communication module 300 may use the user interface 118 to present the request to a user of the computing device 104. For example, the computing device 104 may have a touchscreen display 304 that may display a query to the user about whether to permit the POS terminal to use the computing device 104 for supporting communications. The user may suitably interact with the display 304, such as touching a portion of the screen, to accept the request. Conversely, the user may suitably interact with the display 304, such as touching another portion of the screen, to decline the request. Subsequently, the communication module 300 may send a message to the POS terminal to indicate whether the request is accepted or denied. If accepted, the POS terminal and the computing device 104 may cooperate together such that the computing device 104 can support communications of the POS terminal in accordance with embodiments of the present disclosure. If denied, the POS terminal will not use the computing device 104 to support its communications. In this way, the user of the computing device 104 is selecting whether or not to accept the request.

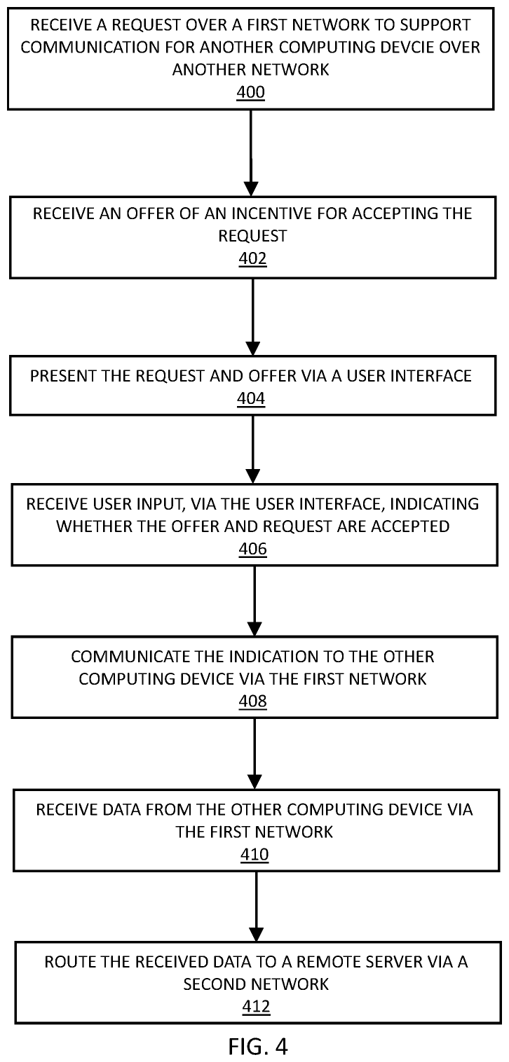

FIG. 4 illustrates a flow chart of an example method implemented at a computing device that is local to a retail environment and that may be used as an alternative for connecting a computing device of the retail environment to a remote server in accordance with embodiments of the present disclosure. In this example, the method is described as being implemented by the computing device 104 shown in FIG. 3, but it should be understood that the method may alternatively be implemented by any other suitable computing device.

Referring to FIG. 4, the method includes receiving 400 a request over a first network to support communication for another computing device over another network. For example, a POS terminal (or other computing device) operating in a retail environment may send, via WLAN, to the computing device 104 shown in FIG. 3 a request to support communication for the POS terminal over the Internet. The POS terminal may have need for support of its communications to a remote server and the network in normally uses has failed, as described by examples provided herein. The computing device 104 may receive the request via communications module 300, which may subsequently pass the request to the communications manager 302.

The method of FIG. 4 includes receiving 402, from the other computing device, an offer of an incentive for accepting the request. Continuing the aforementioned example, the POS terminal may send to the computing device 104 a communication including an offer of an incentive for accepting the request of block 400. For example, the offer may be an offer of a discount for purchase of an item, expedited checkout at a POS terminal within the retail environment, offer of a free item, or the like.

The method of FIG. 4 includes presenting 404 the request and offer via a user interface. Continuing the aforementioned example, the communications manager 302 may use the user interface 118 to present the request and offer to a user of the computing device 104. For example, the display 304 may present the request and offer via an application (also referred to as “app”) residing on the computing device 104. The app may be provided by the retailer for assisting customer's with shopping, conducting purchase transactions, and the like.

The method of FIG. 4 includes receiving 406 user input, via the user interface, indicating whether the offer and request are accepted. Continuing the aforementioned example, the user of the computing device 104 may input a response into the user interface 118 to indicate whether to accept the offer and request. The method of FIG. 4 also includes communicating 408 the indication to the other computing device via the first network. For example, the communications manager 302 may communicate, via a WLAN, to the POS terminal the indication of whether the offer and request are accepted.

The method of FIG. 4 includes receiving 410 data from the other computing device via the first network. Continuing the aforementioned example, the POS terminal may communicate to the computing device 104 data in response to receipt of an indication that the offer and request are accepted. The received data may be designated to be sent to the remote server. The method of FIG. 4 may include routing 412 the received data to a remote server via a second network. For example, the computing device 104 may subsequently route the received data to the remote server via the Internet and/or another suitable network. Further, the computing device 104 may receive data from the remote server designated for the POS terminal and subsequently route the data to the POS terminal.

A record of an acceptance of an offer may be generated and maintained such that a user of the computing device may later redeem the offer. For example, a POS terminal or another computing device of the retail environment may maintain a record of a coupon for the user. Subsequently, the user may subsequently redeem the coupon at the POS terminal. In an example of redeeming a coupon or other type of offer, a cookie or other artifact may be stored on the computing device which confirms that it was made available and participated in the data transfer which would entitle it and the subsequent user to receive the offer.

In accordance with embodiments, data communicated via support of a computing device may be restricted. For example, the POS terminal 102 shown in FIG. 1 may use computing device 104A for supporting communications with the server 114. As an example, the POS terminal 102 may only communicate certain data by support of the computing device 104A and restrict other data from being communicated via the computing device 104A. Financial data and the like of others may be restricted or prevented from being communicated via the computing device 104A. Example data that may be restricted include, but are not limited to, personally identifiable information, financial and payment information, authentication information of the customer (whose transaction is being processed).

In accordance with embodiments, communication by a POS terminal over one network may fail during a purchase transaction for a customer. In response to the network failure, the purchase transaction may be held until communication may be switched for support over a computing device, such as the customer's smartphone. In this instance, the held purchase transaction may continue to be processed through the customer's smartphone upon approval of a request to do so by the customer in accordance with embodiments of the present disclosure.

In accordance with embodiments, data communicated through a supporting computing device may be prioritized. For example, data more critical to operations of a retail environment, such as purchase transaction related communications, may have higher priority than others in order for customers to more efficiently proceed through checkout. Some tasks may be queued or processed with a delay. Any real time response that is required to complete the transaction can use the system and method disclosed herein.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A method comprising:
at a first computing device configured to implement point of sale (POS) functions and to communicate with a second computing device over a first network for supporting the POS functions:
initiating a POS transaction with a customer;
determining a communication condition over the first network;
in response to determining the communication condition, sending a request over a second network for one or more other computing devices to support communication of data about the POS transaction to the second computing device over the second network, the second network being a local area network;
receiving, from the one or more other computing devices, indication whether the request is accepted; and
in response to receipt of an indication that the request is accepted:
switching to use of the second network for communication with the second computing device for supporting the POS transaction with the customer; and
communicating to the one or more other computing devices, via the second network, data associated with the POS transaction for routing to the second computing device for support of the POS transaction.

2. The method of claim 1, wherein the first computing device is configured to:
manage retail server function;
use the first network to conduct retail server functions; and
use the second network to conduct retail server functions.

3. The method of claim 1, wherein determining a communication condition comprises determining that communication over the first network has failed or that communication over the first network is below a predetermined threshold of criterion.

4. The method of claim 1, wherein determining a communication condition comprises determining the communication condition over the Internet.

5. The method of claim 1, wherein sending a request comprises sending the request to the one or more other computing devices over a wireless local area network.

6. The method of claim 1, wherein receiving indication whether the request is accepted comprises receiving indication of user-selection of the acceptance at the one or more other computing devices.

7. (canceled)

8. The method of claim 1, further comprising using the one or more other computing devices to communicate on the second network for engaging a remote computing device for data processing offload in response to receipt of an indication that the request is accepted.

9. The method of claim 8, wherein engaging a remote computing device comprises engaging the remote computing device to one of augmented reality processing, natural language processing, and retail server functions.

10. The method of claim 1, further comprising using the one or more other computing devices for conducting retail server functions in response to receipt of an indication that the request is accepted, and
wherein the method further comprises restricting data communicated over the second network.

11. The method of claim 1, further comprising:
communicating to the one or more other computing devices an offer of an incentive for accepting the request; and
receiving, from the one or more other computing devices, indication of whether the offer of the incentive is accepted,
using the one or more other computing device for communication over the second network only in response to receipt of indication that the offer of the incentive is accepted.

12. The method of claim 11, wherein the incentive includes offer one of a discount for purchase of an item, expedited checkout at a point of sale terminal, and offer of a free item.

13. The method of claim 1, further comprising:
determining whether the communication condition over the first network ended; and
in response to determining that the communication condition over the first network ended, discontinuing use of the one or more other computing devices for communication over the second network.

14. The method of claim 1, further comprising determining which computing devices among a plurality of computing devices meet predetermined criteria, and
wherein sending a request comprises sending the request only to the computing devices that meet the predetermined criteria.

15. The method of claim 1, further comprising:
determining which computing devices among a plurality of computing devices meet predetermined criteria; and
further comprising communicating restricted data to the computing devices for communication over the second network only with the computing devices that meet the predetermined criteria.

16. A method comprising:
at a first computing device:
receiving a request over a first network to support communication for a second computing device over a second network, wherein the support is associated with implementation of point of sale (POS) functions with a third computing device;
receiving user input indicating whether the request is accepted;
communicating the indication to the second computing device via the first network;
receiving data associated with a POS transaction from the second computing device via the first network; and
routing the received data to a third computing device via the second network.

17. The method of claim 16, wherein the support of communication comprises support of communications associated with augmented reality processing, natural language processing, data processing offload, and retail server functions.

18. The method of claim 16, wherein the second computing device comprises a point of sale terminal.

19. The method of claim 16, further comprising:
receiving, from the second computing device, an offer of an incentive for accepting the request; and
receiving user input that indicates whether the offer is accepted.

20. A system comprising:
a first computing device configured to implement point of sale (POS) functions and to communicate with a second computing device over a first network for supporting the POS functions, and wherein the first computing device is configured to:
initiate a POS transaction with a customer;
determine a communication condition over the first network;
send a request over a second network for one or more other computing devices to support communication of data about the POS transaction to the second computing device over the second network in response to determining the communication condition, wherein the second network is a local area network;
receive, from the one or more other computing devices, indication whether the request is accepted; and
switch, in response to receipt of an indication that the request is accepted, to use of the second network for communication with the second computing device for supporting the POS transaction with the customer; and
communicate, in response to receipt of an indication that the request is accepted, to the one or more other computing devices, via the second network, data associated with the POS transaction for routing to the second computing device for support of the POS transaction.
